(19) United States
(12) Patent Application Publication
(10) Pub. No.: US 2016/0132235 A1
(43) Pub. Date: May 12, 2016

(54) Keyboard

(71) Applicant: Steven Scott Capeder, Duvall, WA (US)

(72) Inventor: Steven Scott Capeder, Duvall, WA (US)

(21) Appl. No.: 14/937,298

(22) Filed: Nov. 10, 2015

Related U.S. Application Data
(60) Provisional application No. 62/078,404, filed on Nov. 11, 2014.

(51) Int. Cl. G06F 3/0488

(52) U.S. Cl. CPC G06F 3/04886

(57) ABSTRACT

A keyboard may reduce the number of keys on a keyboard, minimize the distance between common letter strings, and improve typing speed and efficiency. In one embodiment, keys may be arranged in a primarily five-by-five grid, and letter keys may be configured with two letters each. A user may swipe a key in a direction of a letter displayed on that key to select that letter. A predictive dictionary engine may suggest words, and any letter key pressed may be a means to control the selection of suggested words on a prediction display. Border keys may integrate keyboard functions to edges of the keyboard. The keyboard may also work with a QWERTY keyboard or any other program.

### FIELD

This disclosure relates generally to a keyboard.

### BACKGROUND

Existing keyboard systems often utilize a configuration that provides a keyboard layout similar to a typewriter and is most effective when using ten fingers, or a configuration with a keyboard similar to a numeric keypad on a telephone. Neither of these is optimized for the way a user inputs data in the modern mobile society on small devices.

### SUMMARY

The following presents a simplified summary of the disclosure to provide a basic understanding to the reader. This summary is not an extensive overview of the disclosure, nor does it identify key or critical elements of the claimed subject matter or define its scope. Its sole purpose is to present some concepts disclosed in a simplified form as a precursor to the more detailed description that is later presented.

The instant application discloses, among other things, a keyboard. In one embodiment, keys may be arranged in a primarily five-by-five grid, and letter keys may be configured with two letters each, in a combination which may reduce the chance that any combination of keys pressed may result in more than one common word. Keys may be arranged in a manner that allows a user to quickly find and type common letter strings.

Possible words formed by keys typed may be predicted as a user types, and suggested words may be displayed in a top portion of the keyboard, allowing for a quick selection of a desired word. A secondary image of the keyboard layout may be displayed near the suggested words to allow a user to quickly learn the keyboard layout. Any letter or punctuation key pressed may be a means to control the selection of letters on a key or the selection of suggested words on a prediction display. Border keys may integrate functions into the outside edges of a keyboard and may allow a user to switch between an alphabet, number, symbol, or internet keyboard, for example. Keyboard methods and features may work with any software program and keyboard, for example, a QWERTY keyboard.

Many of the attendant features may be more readily appreciated as they become better understood by reference to the following detailed description considered in connection with the attached drawings.

### BRIEF DESCRIPTION OF THE DRAWINGS

FIG. 1 illustrates a keyboard, according to one embodiment.

FIG. 2 illustrates a keyboard, according to one embodiment.

FIG. 3 illustrates a keyboard, according to one embodiment.

FIG. 4 illustrates a keyboard, according to one embodiment.

FIG. 5 illustrates a keyboard, according to one embodiment.

FIG. 6 illustrates a keyboard, according to one embodiment.

FIG. 7 illustrates a keyboard, according to one embodiment.

FIG. 8 illustrates a keyboard, according to one embodiment.

FIG. 9 illustrates a keyboard, according to one embodiment.

FIG. 10 illustrates a keyboard, according to one embodiment.

FIG. 11 illustrates a keyboard, according to one embodiment.

FIG. 12 is a perspective view of a keyboard in a landscape layout, in accordance with at least one embodiment.

FIG. 13 illustrates a flow diagram of a keystroke detection routine for a Keyboard, according to one embodiment.

FIG. 14 illustrates a flow diagram of a keystroke detection routine for a Keyboard, according to one embodiment.

FIG. 15 illustrates a flow diagram of a keystroke detection routine for a Keyboard, according to one embodiment.

FIG. 16 illustrates a flow diagram of a keystroke detection routine for a Keyboard, according to one embodiment.

FIG. 17 illustrates a flow diagram of a keystroke detection routine for a Keyboard, according to one embodiment.

FIG. 18 illustrates a system capable of supporting a Keyboard.

FIG. 19 illustrates a component diagram of a computing device according to one embodiment.

### DETAILED DESCRIPTION

Reference is now made in detail to the description of the embodiments as illustrated in the drawings. In the following detailed description, reference is made to the accompanying drawings which form a part hereof wherein like numerals designate like parts throughout, and in which are shown, by way of illustration, specific embodiments in which the disclosure may be practiced. Various aspects of the illustrative embodiments will be described using terms commonly employed by those skilled in the art to convey the substance of their work to others skilled in the art. However, the embodiments described herein may be practiced with only some of the described aspects. For purposes of explanation, specific numbers, materials, and configurations may be set forth to provide a thorough understanding of the illustrative embodiments. However, the embodiments described herein may be practiced without the specific details. In other instances, well-known features are omitted or simplified in order not to obscure the illustrative embodiments. Further, various operations may be described as multiple discrete operations, in turn, in a manner that may be helpful in understanding the embodiments described herein; however, the order of description should not be construed as to imply that these operations are necessarily order-dependent. In particular, these operations need not be performed in the order of presentation.

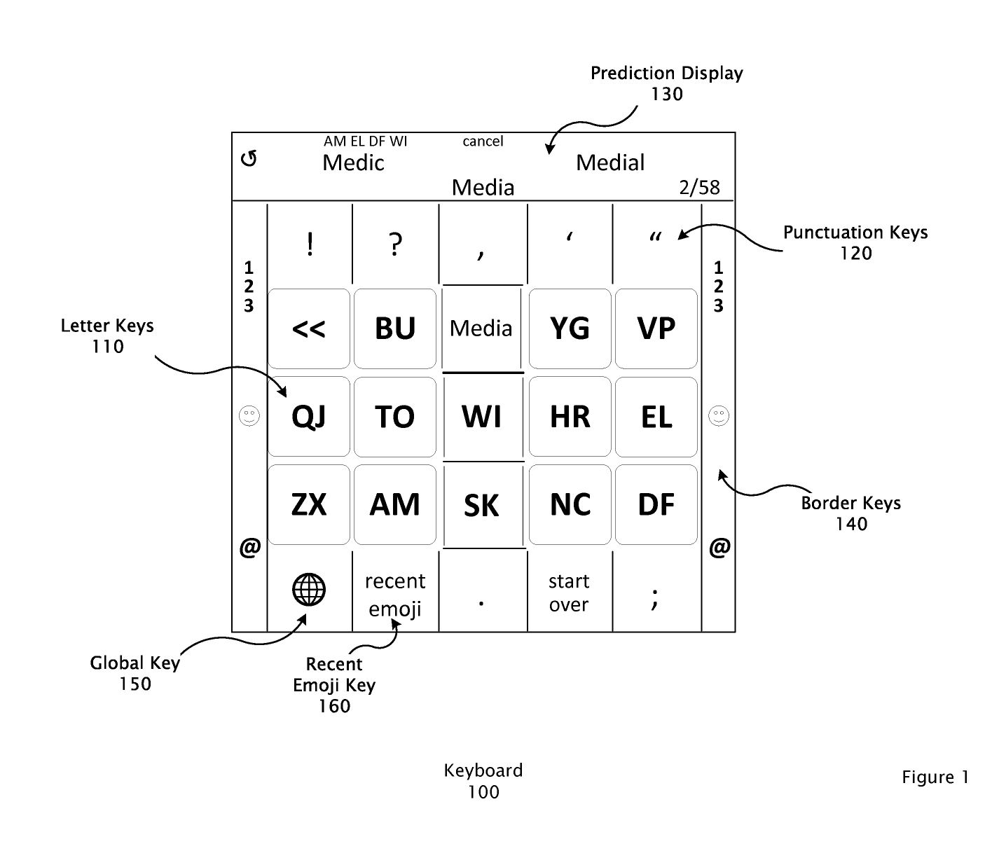

FIG. 1 illustrates Keyboard 100, according to one embodiment. Keyboard 100 may include keys arranged in a primarily five-by-five grid which may include characters, letters, numbers, symbols, and other function keys. Letter Keys 110 may be configured with two letters each to facilitate quick and efficient typing on mobile devices. Letter Keys 110 may be arranged in two columns on a left side and two columns on a right side of Keyboard 100. One finger may cover a pair of columns on the left side of the keyboard, and another finger may cover a pair of columns on the right side of the keyboard. Either finger may cover a middle column of keys. Letter Keys 110 may have dark letters on a light background for easy identification. Other keys may have light characters, letters, numbers, or symbols on a dark background. Keyboard 100 may include Punctuation Keys 120.

Keyboard 100 may use a predictive dictionary engine which may suggest characters, letters, words, numbers, or symbols, such as emoji, for example. Suggestions may be displayed in Prediction Display 130, which may be located in the top portion of Keyboard 100.

The keys of Keyboard 100 may be arranged in a manner that allows a user to quickly find and type common letter strings and reduces the chance that any combination of keys pressed may result in more than one common word. Letter pairings on Letter Keys 110 may also be configured so that for most short words, such as words having three or fewer letters, only one match, or one word suggestion may result from the predictive dictionary. In one embodiment, letters may be paired as B and U, Q and J, T and O, Z and X, A and M, Y and G, V and P, H and R, E and L, N and C, D and F, W and I, and S and K on keys. Letter strings, for example, “GER,” “VER,” “DEN,” “VED,” YPE,” “LD,” “NB,” “CE,” “ED,” and “IN” may be placed in a logical way, for example, in the right-sided columns of Keyboard 100, or in another arrangement that allows the user to quickly locate and type common 2-3 letter strings.

To type the word “AND,” the user may tap the keys “AM,” “NC,” and “DF.” The predictive dictionary engine may look at each possible combination of those keys: AND, ANF, ACD, ACF, MND, MNF, MCD, and MCF. Among these combinations, “AND” may be the only word in the predictive dictionary, and that word may be suggested and displayed on Prediction Display 130.

While Letter Keys 110 may be configured to minimize the number of common word options after each keystroke, there may be multiple word suggestions possible for any key combination since Letter Keys 110 may include two letters each. For example, if the user types “AM,” “EL,” “DF,” and “WI,” the predictive dictionary engine may suggest MEDIA, MEDIAL, MEDIC, MEDICAL, MEDICINE, and MEDIUM, or whatever other words match the letters typed and are in the predictive dictionary. The user may customize Keyboard 100 so that a key combination may provide a particular suggestion.

In another embodiment, an “abc” mode may be available. In “abc” mode, a user may manually type a single character, letter, number, or symbol using a key having an item pair. For example, the user may tap a key and a letter on the left side of the key may be typed in lowercase. If, rather than typing, the user swipes down, letter on the right side of the key may be typed in lowercase. Swipe left or right before releasing it to select a left-sided or right-sided item on that key, respectively. If the user swipes left, a letter on the left side of the key may be typed in uppercase, while if the user swipes right, a letter on the right side of the key may be typed in uppercase.

For example, if a key contains the letter pair “HR”, and the user wishes to select “H,” the user may tap the “HR” key and swipe left before releasing it to type “H.” These actions may allow the user to type words that are not the predictive dictionary, for example, proper names. Real-time visual confirmation of typed keys may be displayed at a position on Prediction Display 130. Pressing a space key may change out of “abc” mode.

Prediction Display 130 may provide suggestions in descending order of frequency of use in a language or a user's frequency of use, for example. Suggestions may also be based on other factors such as personal preferences, census data, and contexts, such as time or location. According to one embodiment wherein words are typed, three word suggestions may be displayed in Prediction Display 130 at one time, with the most common, likely, or highest-recommended word in the center, the second such word on the right, and the third such word on the left, for example. Any letter key pressed may become a means to control the selection of words on Prediction Display 130 by swiping the key after pressing it and before releasing it. For example, before releasing a typed key, the user may swipe down, right, or left to select a word in the center, right, or left position, respectively. Selection of a word by swiping the last key pressed may also enter a trailing space after the selected word, or it may display common punctuation keys in place of the normal letter keys on the keyboard, for example. The user may also select word suggestions by using other keys, for example, a space key, or thumb key, key. A space key and thumb key may not be in a standard Keyboard 100 layout, but may be available in other embodiments. In one embodiment, a thumb key may add flexibility to the keyboard by allowing a user to type with two fingers and a thumb, where the two fingers each commit to one column and the thumb commits to the thumb key. This may make typing quicker and more ergonomic for the user. In addition to ease of use, the thumb key may allow increased word completion speed.

The user may view, or toggle between, multiple pages of word suggestions displayed on Prediction Display 130. In one embodiment, the user may hold the last key pressed and make a large swipe right to view additional pages or make a large swipe left to view previous pages of word suggestions. In another embodiment, page forward and page backward keys may allow the user to toggle between pages when an alpha key has been pressed but before a word has been selected.

Border Keys 140 may comprise strips along the side, top, and bottom edges of Keyboard 100. Border Keys 140 may offer advantages of informing the user of what swiping into Border Keys 140 from the outside edge of the keyboard will do while taking up a small amount of space on the keyboard. Border Keys 140 may serve functions typically accomplished with buttons, which take up more space on conventional keyboards. Border Keys 140 may allow the user to switch between various keyboards such as a letter, number, symbol, or internet keyboard, or they may facilitate editing, for example. Border Keys 140 may hold as many as 16 or more separate items. Border Keys 140 may have a medium-tone background with dark lettering or a light-colored background with dark lettering, for example, to distinguish Border Keys 140 from other keys. In one embodiment, the top portion of the top row of keys may turn into border keys and serve a function of a mouse to facilitate the editing of text, emails, documents, and other files. Similarly, the bottom portion of the bottom row of keys may turn into border keys and serve the functions of text formatting, or other common uses.

Keyboard 100 may include keys that serve various other functions; for example, Global Key 150 may switch between Keyboard 100 and other keyboard applications on a device; a microphone key may allow for dictation for creating recordings or text; an attachment key may attach files to a message; and a communicate key may initiate phone calls, emails, or text messages. Recent Emoji Key 160 may allow the user to view and select recently used symbols such as emoji. A dictionary key may display word meanings, synonyms, and antonyms, and a translation key may convert words and other input into other languages, for example.

Another embodiment may provide an ability to type common words and word strings by simultaneously pressing down multiple keys, dramatically improving typing ease and speed. For example, the user may type “THE” by simultaneously pressing TO with the index finger, HR with the middle finger, and EL with the ring finger, and then swiping all three fingers down at the same time. The same may be done with other common words like “AND,” “OF,” and “THEY.”

Keyboard 100 may allow the user to edit input such as text and audio, for example, and convert data into a multimedia format which may be shared via text, email message, or social media. For example, the user may use the microphone key to dictate a message which may be converted into text. The text may be converted into another multimedia format, such as a shape containing the message, a photo, meme, or video clip, for example.

Keyboard 100 may be configured for use on devices such as computers, laptops, tablets, smartphones, smartwatches, and intelligent eyewear, for example, and may allow for a split, tilted, and landscape keyboard configuration to improve user efficiency and comfort. When the keyboard is split into two sections, the middle column may be replicated and available on both sides, turning the keyboard into a six-column keyboard, for example. Keyboard 100 may also allow a user to use a device, such as an iPhone®, for example, as a keyboard and mouse to control another device, such as an iPad®. Keyboard methods and features may be configured to work with any software program and keyboard, for example, a QWERTY keyboard.

In one embodiment, the user may never log off of a Keyboard 100 application. In another embodiment, the user may log on and off, which may enable a server to gather user information when they register and track their keystrokes and searches, for example. A person skilled in the art will understand that the predictive keyboard may have various configurations and operate based on various user commands.

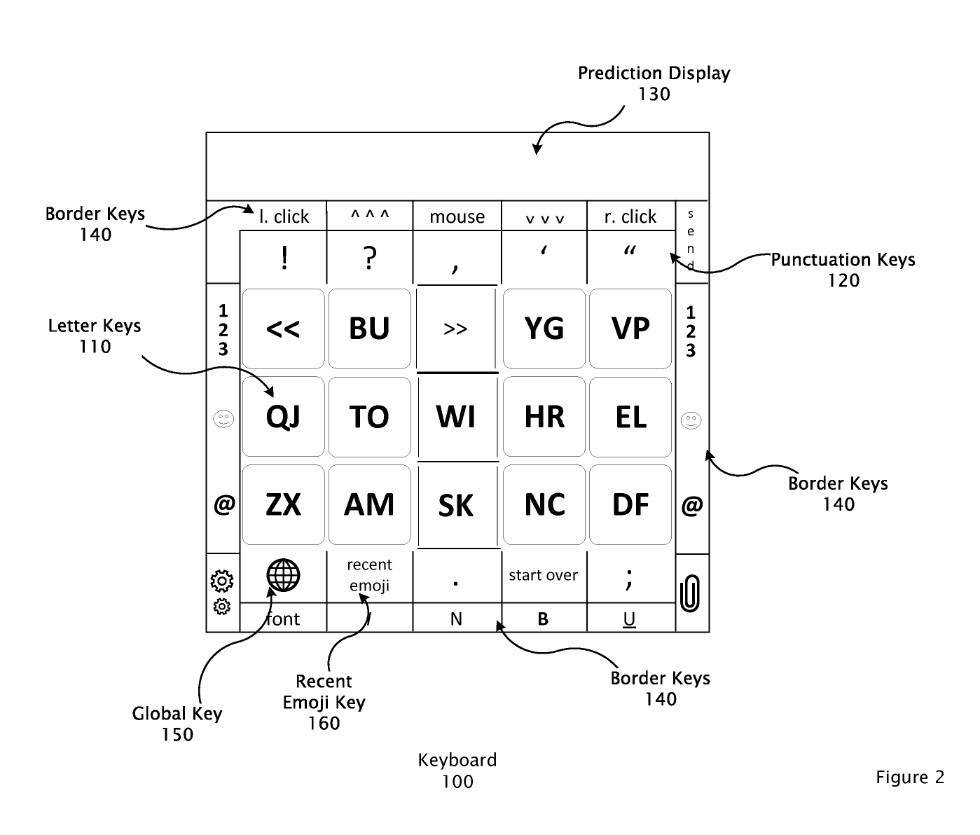

FIG. 2 illustrates Keyboard 100, according to one embodiment. Border Keys 140 may include formatting keys, which may be located along the top and bottom edges of Keyboard 100. Formatting keys may provide functions of a traditional mouse; for example, left click, right click, and scroll up and down. Formatting Border Keys 140 may also provide functions to edit font, italicize, bold, underline, normalize, strikethrough, attach files, and configure or setup, for example.

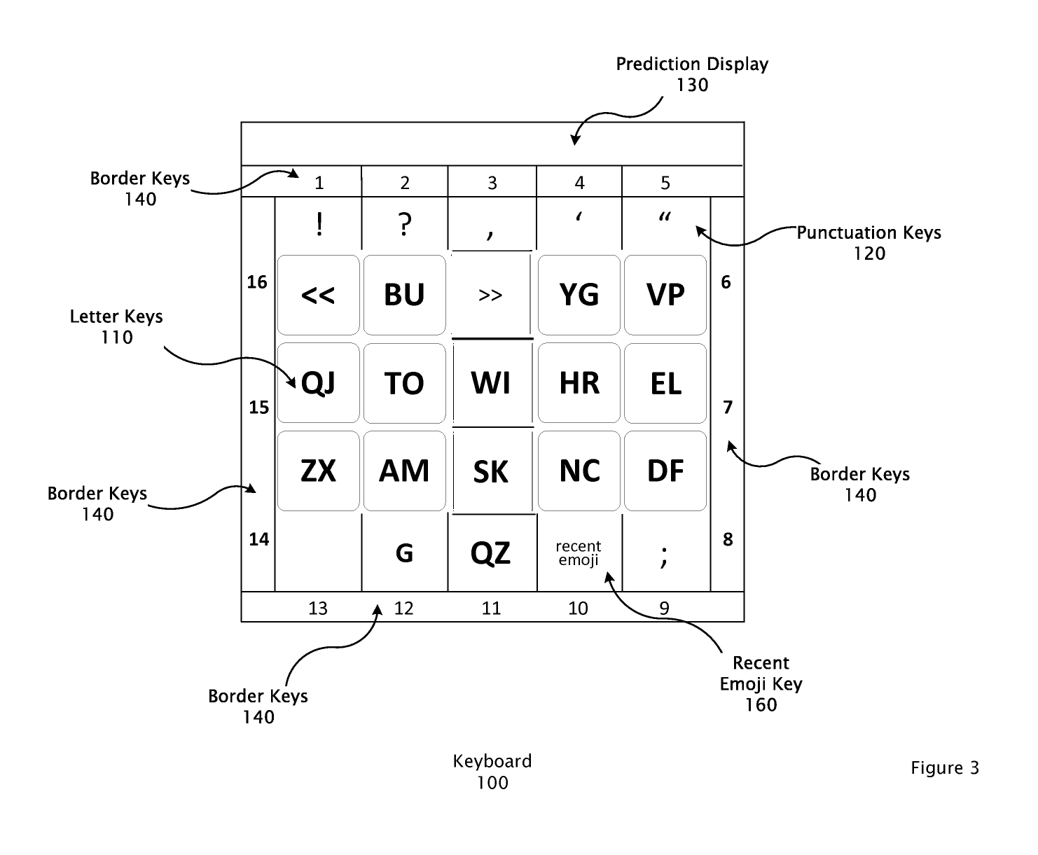

FIG. 3 illustrates Keyboard 100, according to one embodiment. This example illustrates the ability for Border Keys 140 to hold a plurality of separate items, for example, up to 16 or more items.

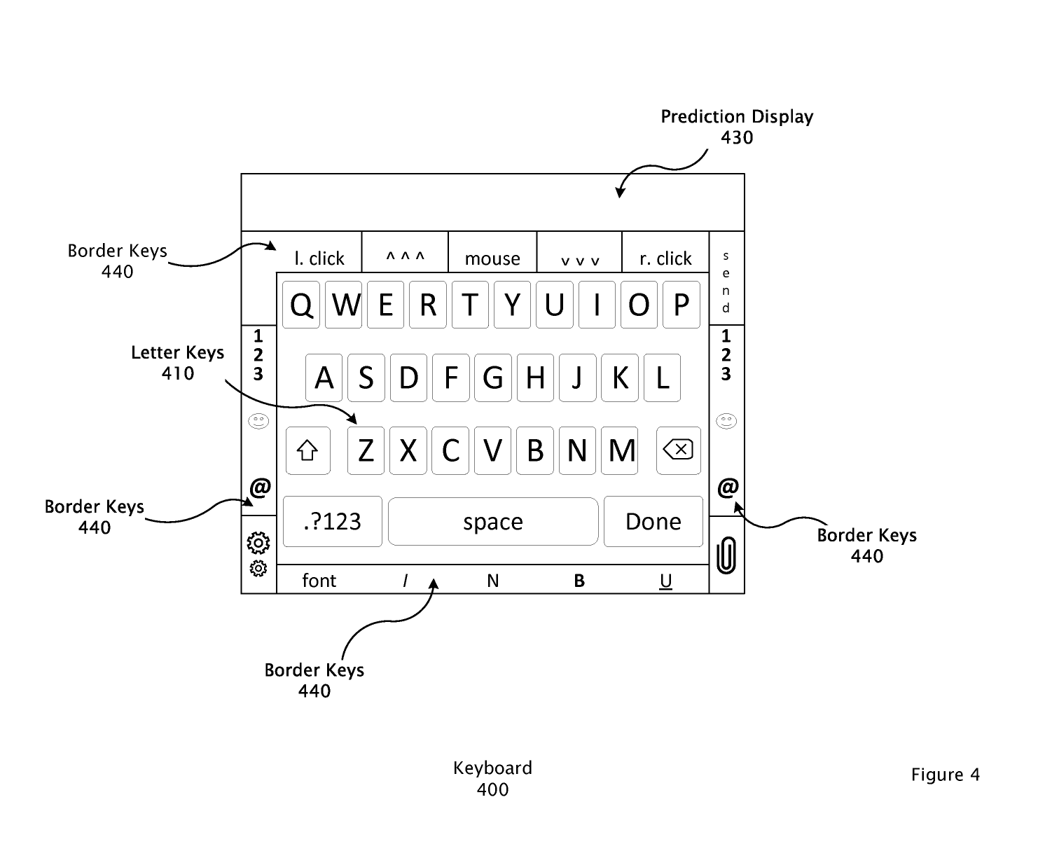

FIG. 4 illustrates Keyboard 400, according to one embodiment. In this example, Keyboard 400 may work with a QWERTY keyboard arrangement, which may include Letter Keys 410 having a single letter per key, a Prediction Display 430, and Border Keys 440. This embodiment may improve typing speed and efficiency while reducing layout learning time for users who are familiar with a QWERTY key configuration. For example, when a user presses the letters “T” and “H” on a QWERTY keyboard, the predictive dictionary engine may suggest the words “THE,” “THIS,” and “THAT.” In this example, the user may perform actions using the “H” key to select a desired word and to add a space following a selected word.

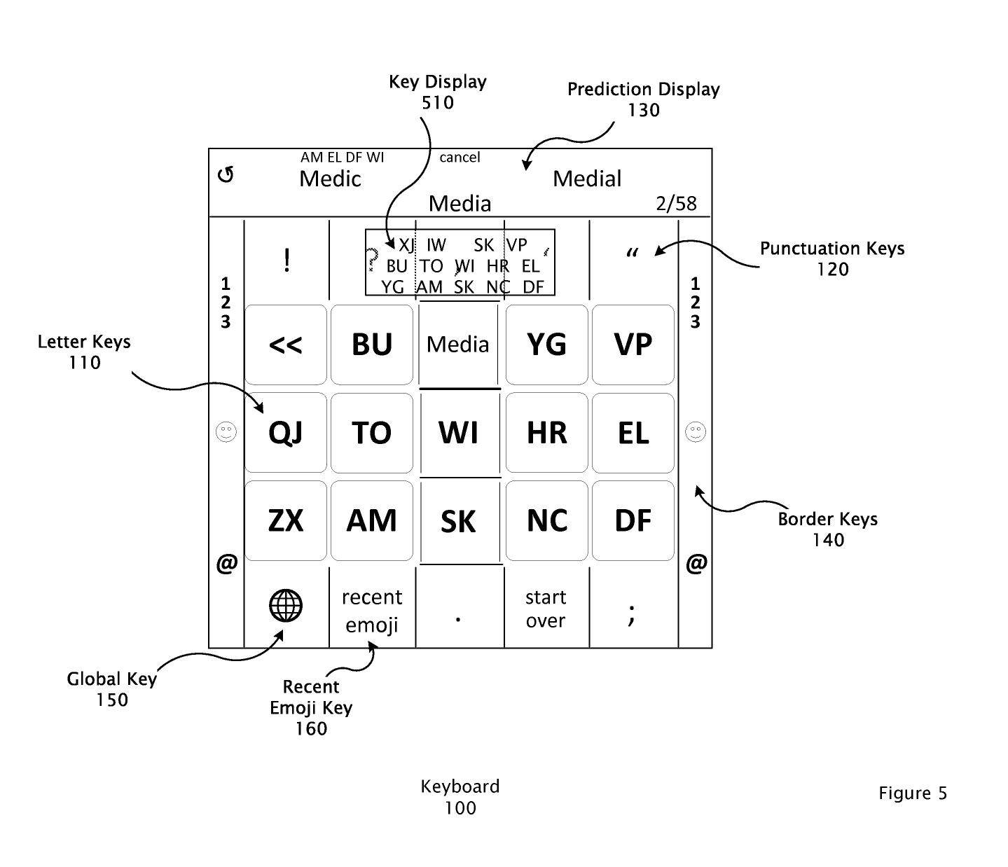

FIG. 5 illustrates Keyboard 100, according to one embodiment. Key Display 510 may provide a small image of a keyboard layout, allowing a user to type while looking at Display 510 rather than looking at keys. As the user taps a key, a corresponding image of that key on Display 510 may light up a different color or shade to inform the user that they typed the right key. Key Display 510 may be light gray or another color or shade, which may reduce distraction to the user.

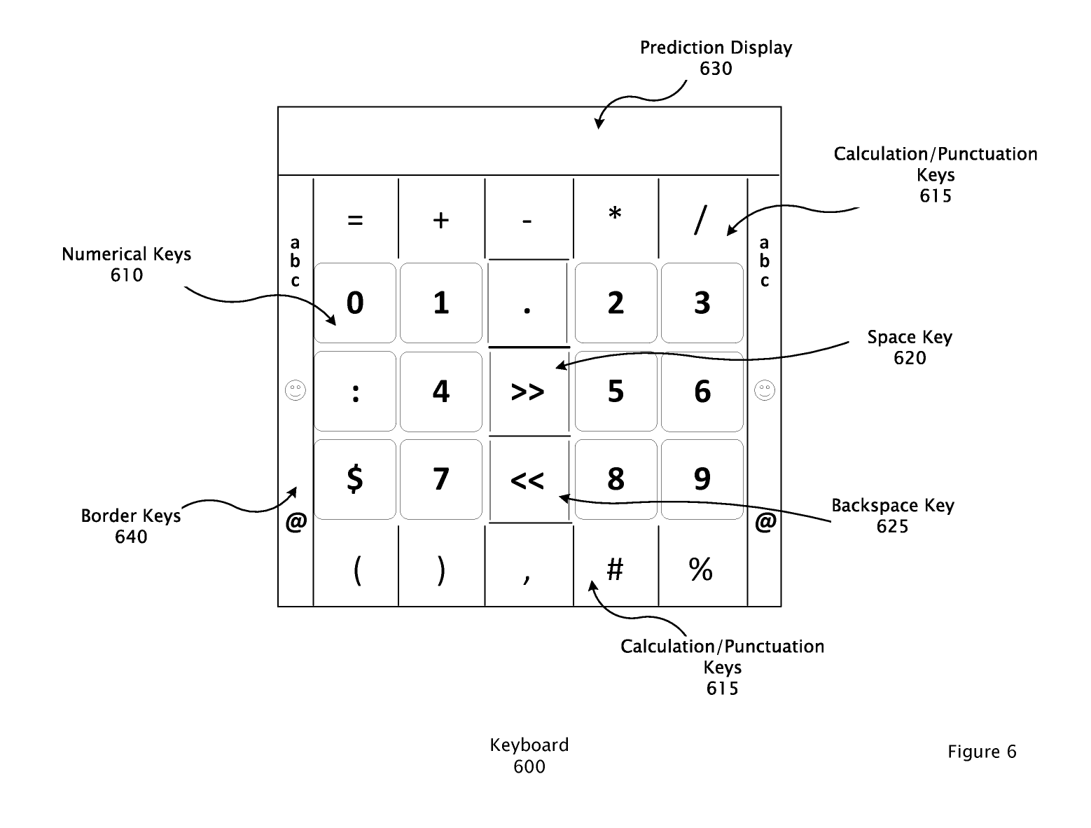

FIG. 6 illustrates Keyboard 600, according to one embodiment. Keyboard 600 may comprise a number keyboard and may include Numerical Keys 610 and other keys, for example, Calculation/Punctuation Keys 615, which may facilitate quick and efficient numerical typing or computing on mobile devices. Space Key 620 may allow a user to enter a space, and backspace Key 625 may allow a user to type a backspace. Border Keys 640 may allow a user to switch between keyboards.

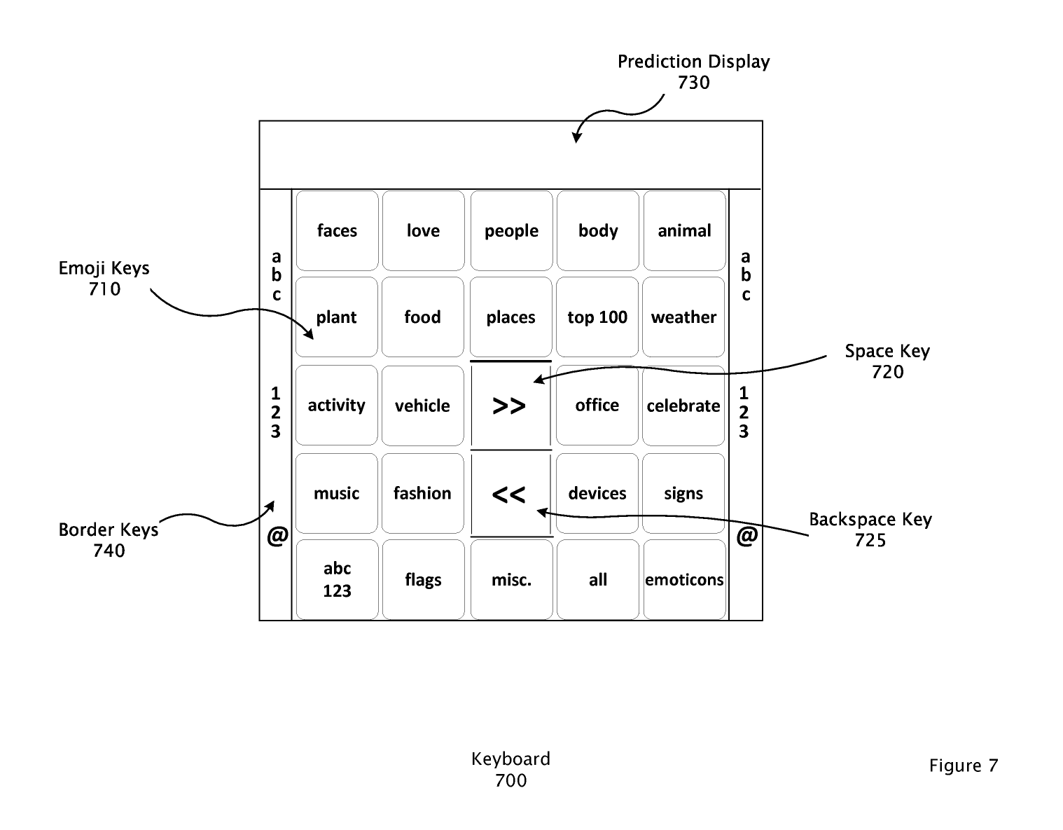

FIG. 7 illustrates Keyboard 700, according to one embodiment. Keyboard 700 may include a database of symbols, such as emojis, which may be organized by category and subcategory. The database may include emojis defined in Unicode or other emojis. A user may view the description of an emoji before selecting it by tapping on any Emoji Keys 710, for example. The user may swipe up to decline any Emoji Keys 710 after viewing its description. In another embodiment, the user may browse and select emojis using a directional key to move up, down, left, right, and diagonally, for example. Space Key 720 may allow a user to enter a space, and backspace Key 725 may allow a user to type a backspace. Border Keys 740 may allow a user to switch between keyboards.

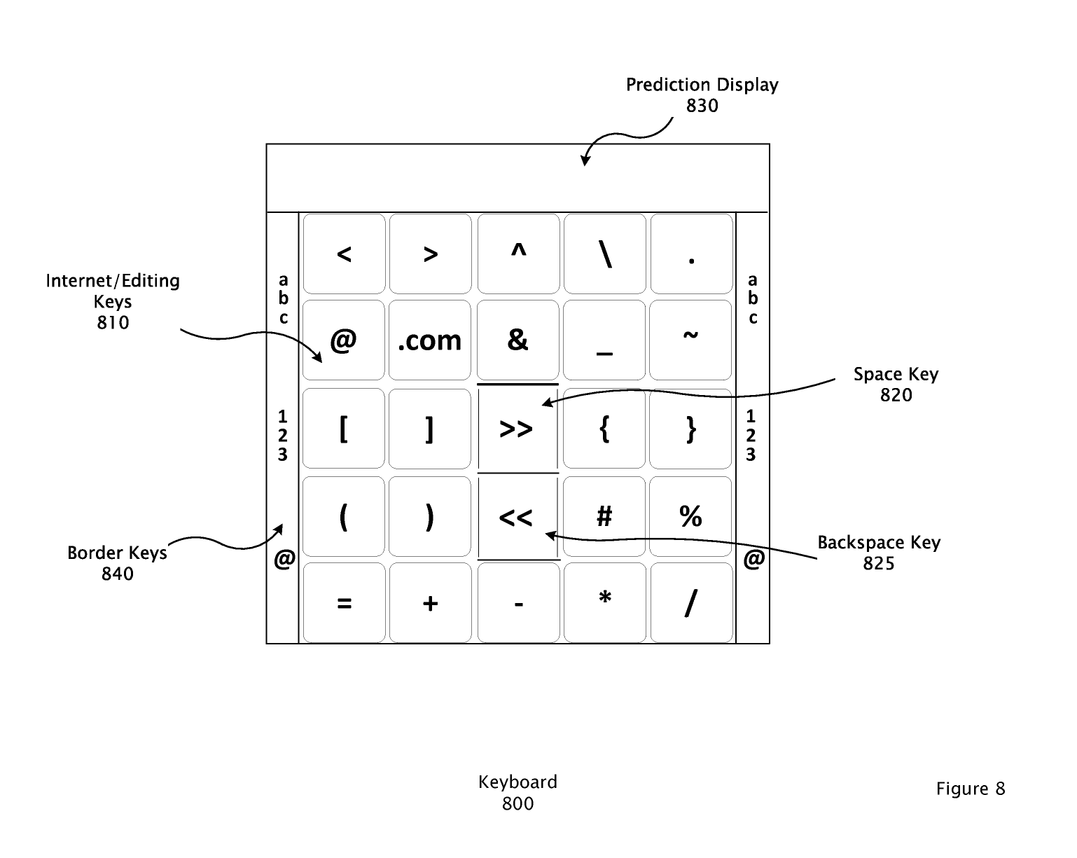

FIG. 8 illustrates Keyboard 800, according to one embodiment. Keyboard 800 may include Internet/Editing Keys 810, which may facilitate editing, computing, communicating, and internet activity, for example. Space Key 820 may allow a user to enter a space, and backspace Key 825 may allow a user to type a backspace. Border Keys 840 may allow a user to switch between keyboards.

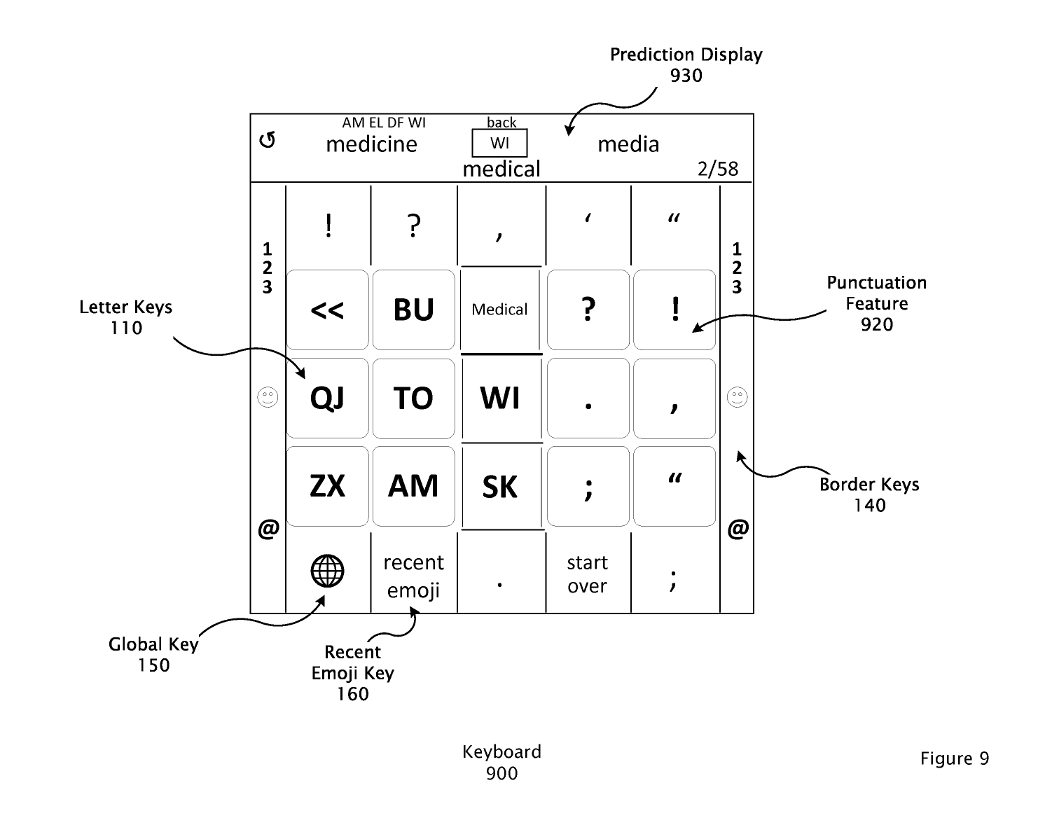

FIG. 9 illustrates Keyboard 900, according to one embodiment. Keyboard 900 may include a Punctuation Feature 920, which may provide an efficient means of adding punctuation to text. When a user selects a word on Prediction Display 930 using the last letter key pressed, the letter keys on an opposite side of the keyboard may convert into punctuation keys for as long as the original letter key remains pressed, for example. In another embodiment, both sides of a letter keyboard, or all Letter Keys 110, may convert into punctuation keys after a user selects a word on Prediction Display 930. Pressing a punctuation key in this manner may add the punctuation to the end of all words on the Prediction Display 930, for example. This action may also give the user the ability to add multiple punctuation marks and may disable the Letter Keys 110 at the same time. As soon as the user finishes selecting the desired word and punctuation, the punctuation keys may instantly revert to Letter Keys 110.

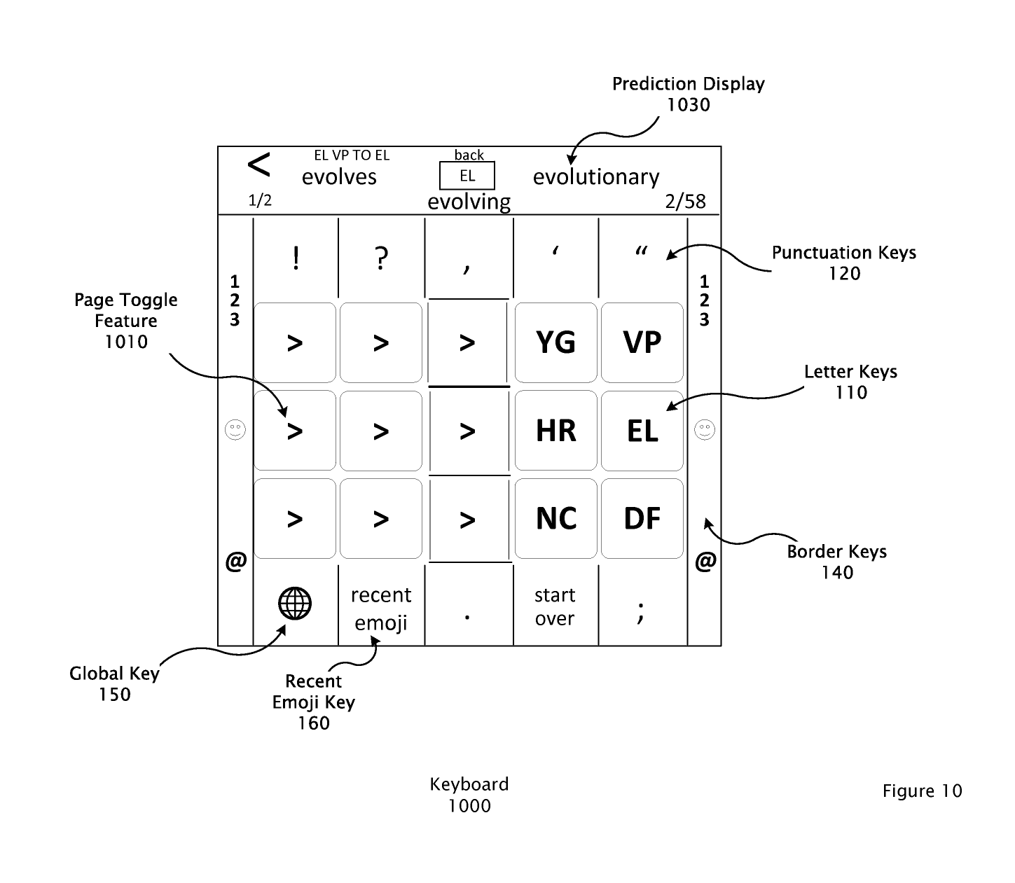

FIG. 10 illustrates Keyboard 1000, according to one embodiment. When the user types a letter string and sees suggestions on Prediction Display 1030, the user may perform actions to view additional pages of suggestions if additional pages are indicated in Prediction Display 1030. For example, a user wishing to type the word “EVOLVES” may first press the “EL” key, which may be highlighted in Prediction Display 1030 although a word in Prediction Display 1030 has not been highlighted. After pressing the “EL” key, the user may then type the keys “VP,” “TO,” “EL” and see the words “EVOLVED,” “EVOLUTION,” and “EVOLVED” on page “1/2,” or one of two pages, of Prediction Display 1030. To view additional words, such as “EVOLVES,” the user may then either 1) Press the keys “VP” and “EL,” in which case Prediction Display 1030 may show “EVOLVES,” or the user may 2) toggle to page “2/2” and select “EVOLVES.” In one embodiment, the user may toggle between pages by tapping a letter key and making a large swipe right to scroll forward to more pages, or by tapping a letter key and making a large swipe left to return to previous pages.

In another embodiment, and as shown in FIG. 10, Keyboard 1000 may include Page Toggle Feature 1010, which may provide another efficient means to scroll to additional pages on Prediction Display 1030. In this example, when suggestions are displayed on Prediction Display 1030 and the user keeps a letter key pressed for a short time, the opposite side of the keyboard may convert into page forward keys for as long as the first key pressed remains in the central position on Prediction Display 1030.

In this example, if the user wishes to type a longer word, if there are multiple lemmas, or if there are many pages of choices in Prediction Display 1030, the user may perform the following actions, for example: The user wishing to type the word “EVOLVES” may type the keys “EL,” “VP,” “TO,” and “EL” and keep their thumb on the “EL” key while viewing the three word choices in Prediction Display 1030. The user may see that “EVOLVES” is not a choice on page “1/2,” but given that three lemmas of “EVOLVE” are on page “1/2,” it may make sense to the user that their desired word is likely on page “2/2.” When there is a very brief delay in keeping a key pressed, in this case the “EL” key, Page Toggle Feature 1010 may convert Letter Keys 110 on the opposite side of the keyboard and three middle column keys into page toggle keys, which may allow the user to move to the next page on Prediction Display 1030. In this example, the user may simply hit any of the page toggle keys once with their left thumb and go to page “2/2” on Prediction Display 1030 while keeping their right thumb on the “EL” key. Once on page “2/2,” the user may see the word “EVOLVES” and then move their right thumb, still on the “EL” key, left to select the word “EVOLVES.”

In another embodiment, the features discussed above may be implemented on a keyboard with a conventional QWERTY layout.

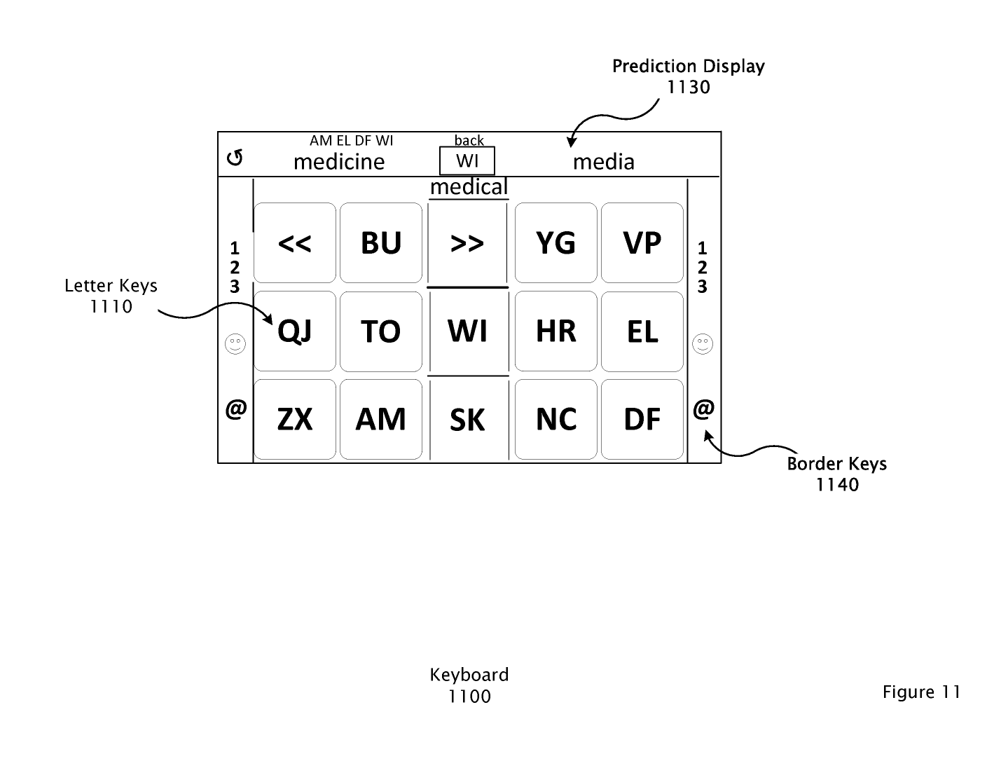

FIG. 11 illustrates Keyboard 1100, according to one embodiment. Reduced height Keyboard 1100 may include the ability to toggle the keyboard into a 15-key keyboard, or it may serve as a default keyboard for a device such as an Apple Watch™, for example. If a user wishes to have the keyboard smaller, a feature may allow the user to toggle the keyboard from a 25-key keyboard into a 15-key keyboard, for example. The other keyboards may remain 25 keys, and the keys may get shorter in order to keep the same height as the 15-key ABC keyboard. Reduced Key Height Keyboard 1100 may comprise an alphabet keyboard with Letter Keys 1100, a number keyboard, symbol or emoji keyboard, or internet keyboard, for example, or a QWERTY keyboard. It may also include Prediction Display 1130 and Border Keys 1140.

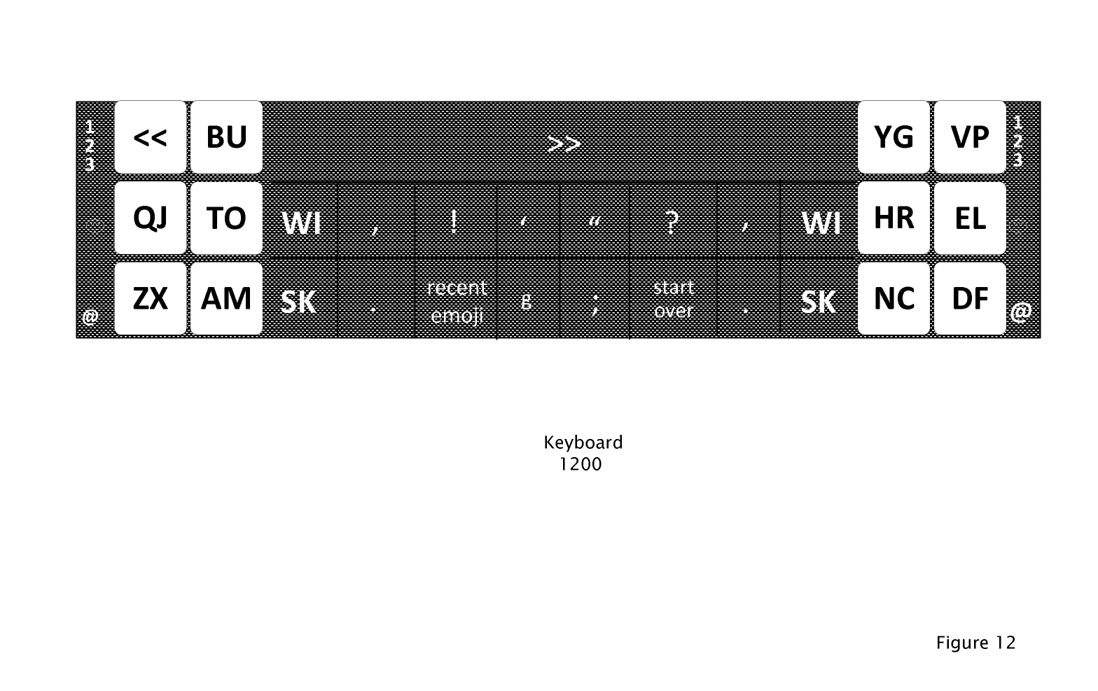

FIG. 12 is a perspective view of Keyboard 1200 in a landscape layout, in accordance with at least one embodiment.

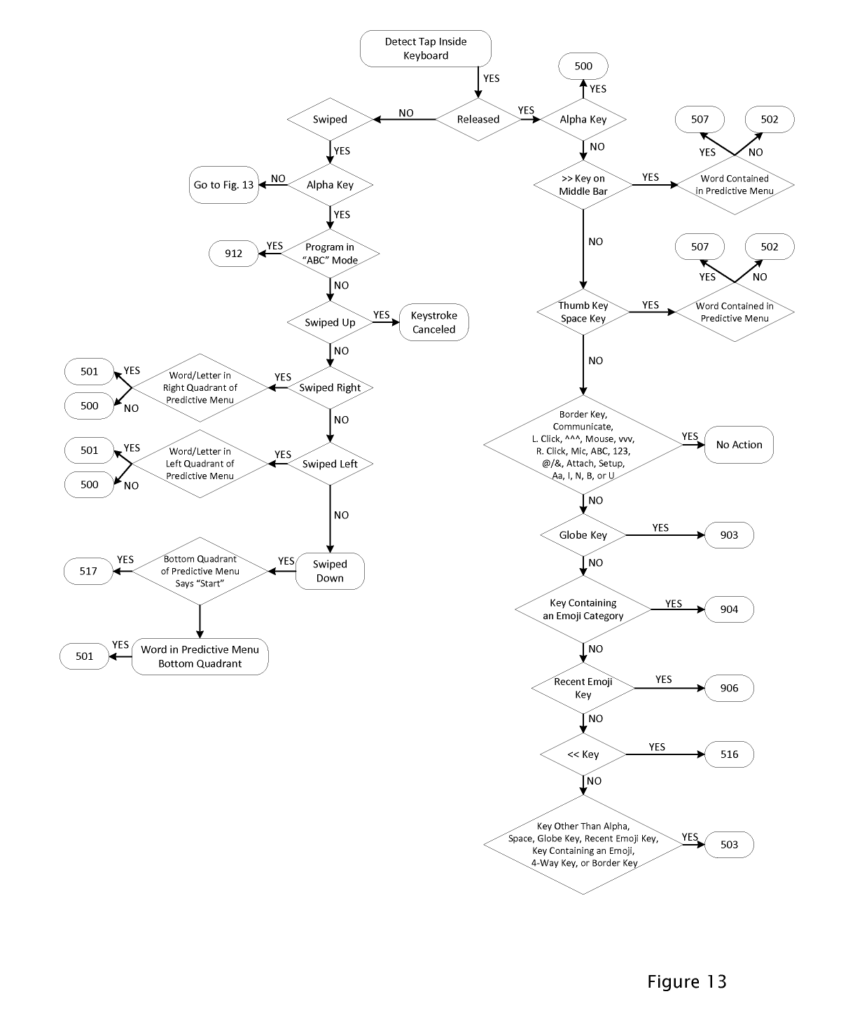

FIG. 13 is a flow diagram of a keystroke detection routine for Keyboard 100 in accordance with one embodiment. The example flow diagram may include one or more operations or modules as illustrated by the blocks, which may represent operations which may be performed in a method or functional modules for Keyboard 100. Operations may be listed here:

| | |
|---|---|
| 500 | If program is in regular mode, it sends the two letters on key as |
| | input to dictionary program. If program is in “abc” mode, it types |
| | the lower case letter on the left side of the alpha key. |
| 501 | Word located in that area of the predictive menu is typed followed |
| | by a space. |
| 502 | A space is typed. |
| 503 | If there is no word in the predictive menu, the character inside that |
| | key is typed. If there is a word in the predictive menu, that charac- |
| | ter is added to all of the word choices contained in the predictive |
| | menu. |
| 507 | Word on bottom quadrant will be typed, and a space will be added |
| | after it. |
| 510 | If there is no word in the predictive menu, swiping up turns on |
| | CAPS LOCK, swiping down is the ENTER or RETURN function, |
| | and swiping right turns on “abc” mode. |
| | If there are words in the predictive menu, the user selects from |
| | words or additional pages as follows: 1) Tapping and releasing |
| | the >> key picks the word in the bottom quadrant; 2) Tapping and |
| | swiping left chooses the word in the left quadrant; 3) Tapping and |
| | swiping right chooses the word in the right quadrant; 4) Tapping |
| | and swiping up cancels out the last keystroke; 5) Tapping and a |
| | large swipe right scrolls to more pages if more pages are indicated |
| | in the predictive menu; 6) Tapping and swiping large left goes back |
| | to previous pages if there are previous pages indicated in the |
| | predictive menu or else serves as the START OVER function; 7) |
| | When a word is chosen from the predictive menu, a space is placed |
| | after it. |
| 512 | No action. |
| 515 | User can swipe up, down, left or right and pick the emoji |
| | subcategory listed in the predictive menu. |
| 516 | A backspace is entered. |
| 517 | All keystrokes in the gray predictive bar are cleared out. |
| 902 | Text has been highlighted via mouse cursor. |
| 903 | Changes to QWERTY keyboard. |
| 904 | All the emojis for that category are shown on a new menu. |
| 906 | A new menu opens showing the most recently selected emojis. |
| 907 | If the key is not lit up, it will light up, and anything user types will |
| | become highlighted. If the bottom of the key is lit up, it will return |
| | to normal and anything the user types will be in normal type. |
| 908 | If the key is not lit up, it will light up, and anything user types will |
| | become italicized. If the bottom of the key is lit up, it will return to |
| | normal and anything the user types will be in normal type. |
| 909 | Any text typed will be normal, and if the highlight, italics, bold, or |
| | underline keys are lit up, they will stop being lit up. |
| 910 | If the key is not lit up, it will light up, and anything user types will |
| | be bold. If the bottom of the key is lit up, it will return to normal |
| | and anything the user types will be in normal type. Alternatively, |
| | this feature can be turned off, in which case swiping down will |
| | type the character contained inside the key. |
| 912 | If the user swipes right, the upper case letter on the right side of |
| | the key will be typed. If the user swipes up, the keystroke will be |
| | canceled out. If the user swipes left, the lower upper letter on the |
| | left side of the key will be typed. If the user swipes down, the |
| | lower case letter on the right side of the key will be typed. |
| 913 | Swiped down from the predictive menu area and down into the key |
| | or from the left edge of the keyboard into the key. |
| 914 | Swiped down from the predictive menu area and down into the |
| | key. |
| 915 | A unique user interface opens, allowing the user to email, text, |
| | surf the internet, or use their phone. |
| 916 | Swiped up from under the keyboard area and up into the key. |
| 917 | Swiped from the outside the keyboard edge and towards the center |
| | of the keyboard. |
| 918 | If swiped left, cheat sheet is turned on/off. If swiped right, the |
| | main alpha keys are turned on/off. If swiped up, the “key turns |
| | orange when tapped” function is turned on/off. |

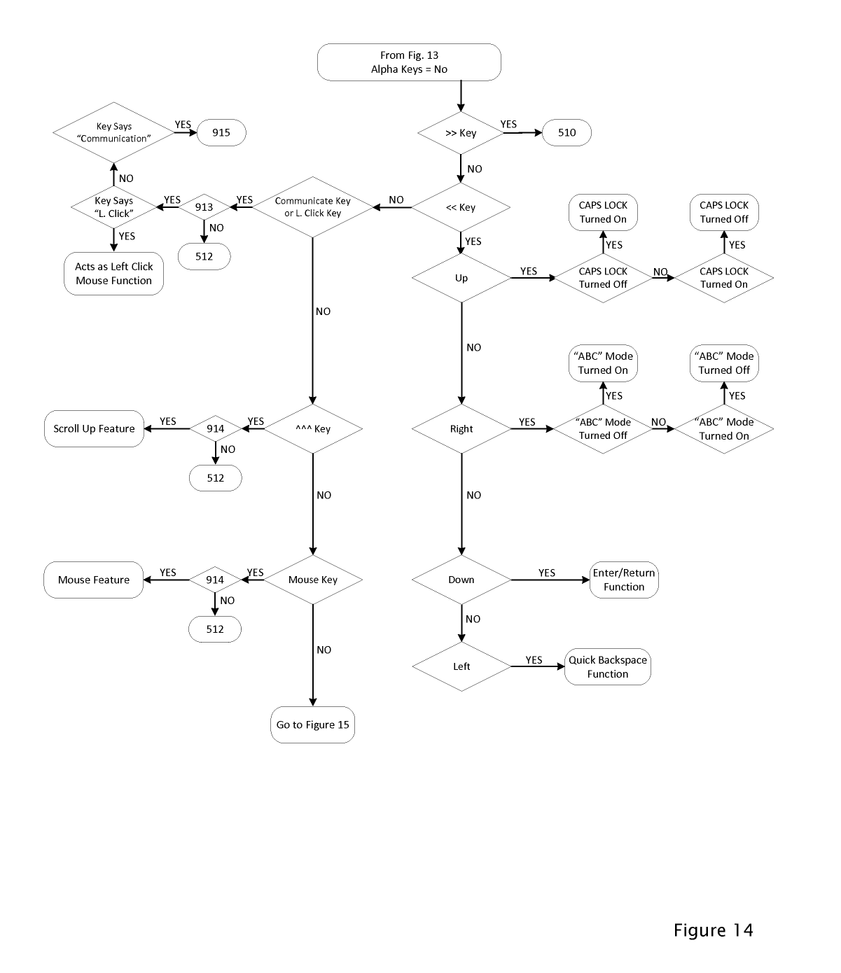

FIG. 14 is a flow diagram of a keystroke detection routine for Keyboard 100 in accordance with one embodiment. The example flow diagram may include one or more operations or modules as illustrated by the blocks, which may represent operations which may be performed in a method and/or functional modules for Keyboard 100.

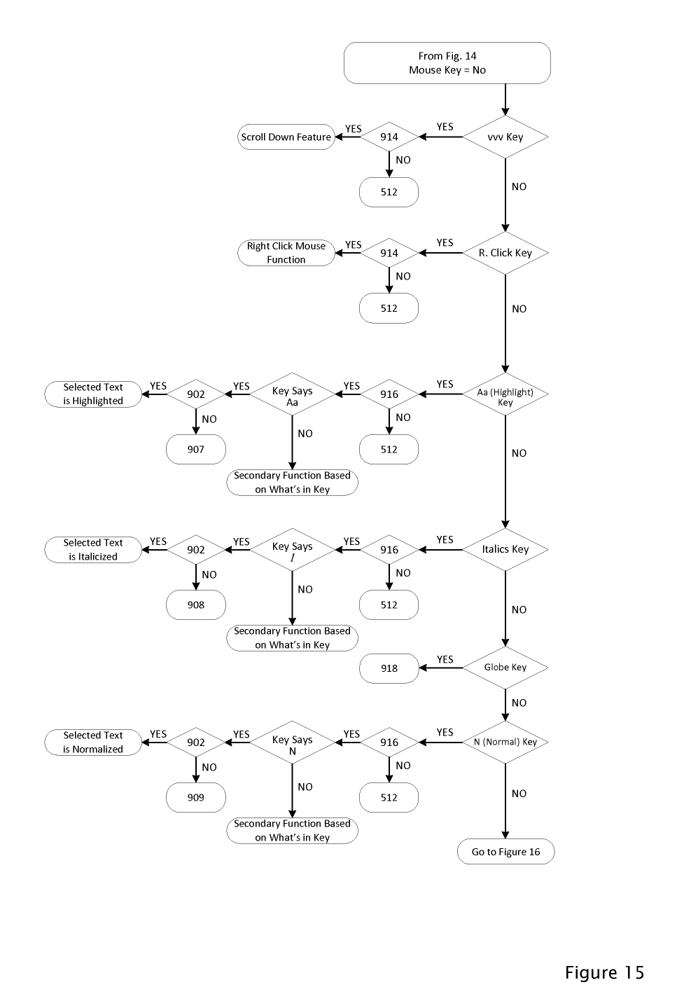

FIG. 15 illustrates a flow diagram of a keystroke detection routine for Keyboard 100 in accordance with one embodiment. The example flow diagram may include one or more operations or modules as illustrated by the blocks, which represent operations which may be performed in a method and/or functional modules for Keyboard 100.

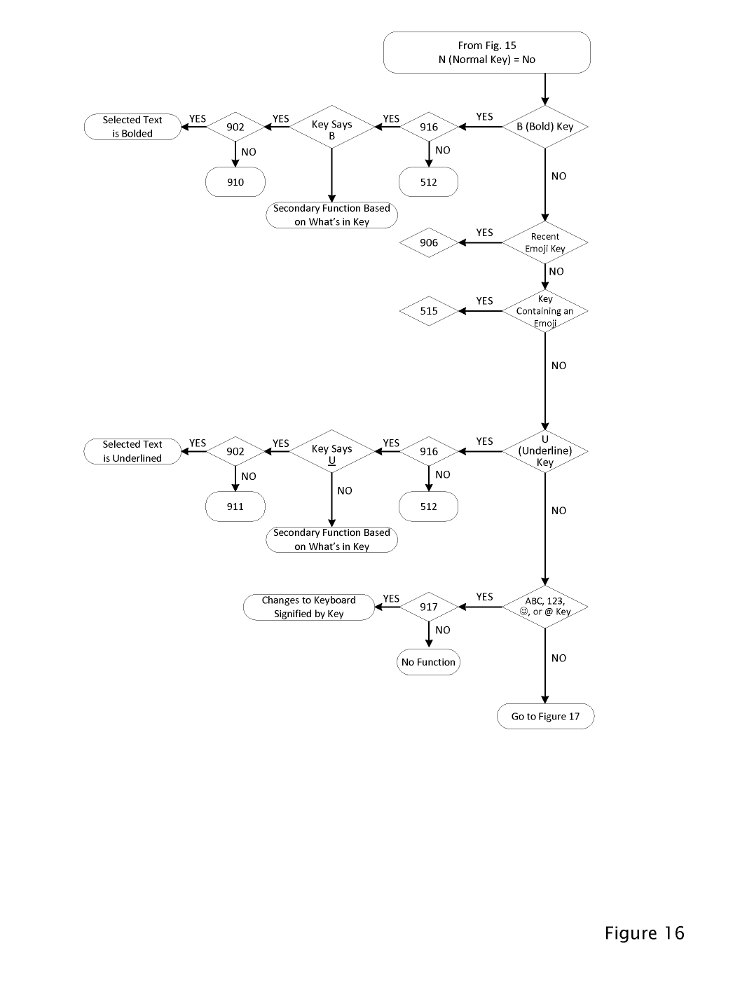

FIG. 16 illustrates a flow diagram of a keystroke detection routine for Keyboard 100 in accordance with one embodiment. The example flow diagram may include one or more operations or modules as illustrated by the blocks, which represent operations which may be performed in a method and/or functional modules for Keyboard 100.

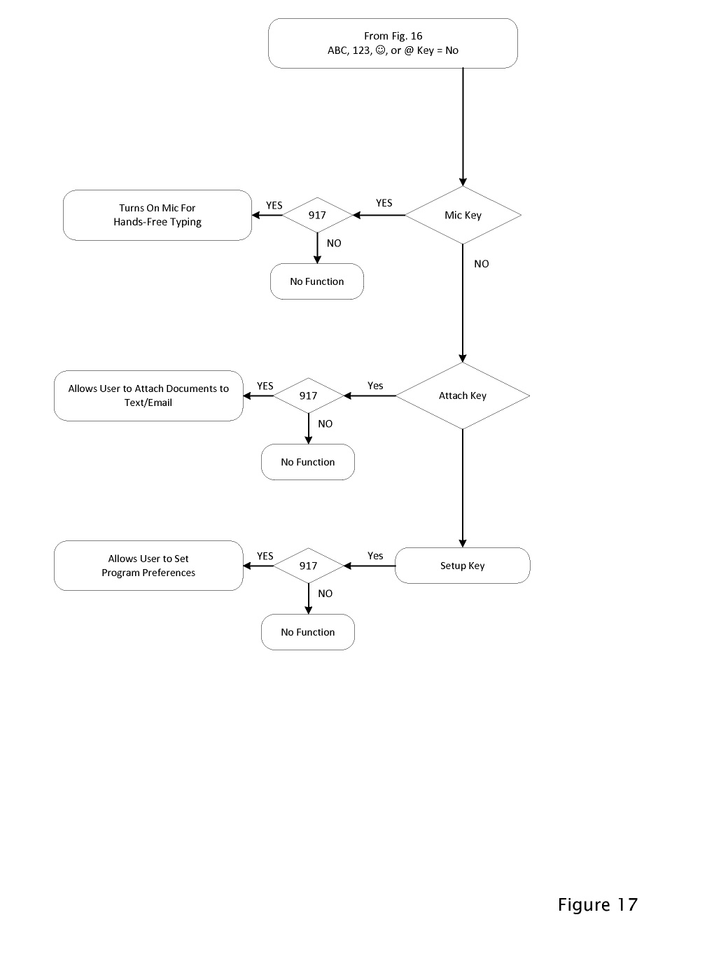

FIG. 17 illustrates a flow diagram of a keystroke detection routine for Keyboard 100 in accordance with one embodiment. The example flow diagram may include one or more operations or modules as illustrated by the blocks, which represent operations which may be performed in a method and/or functional modules for Keyboard 100.

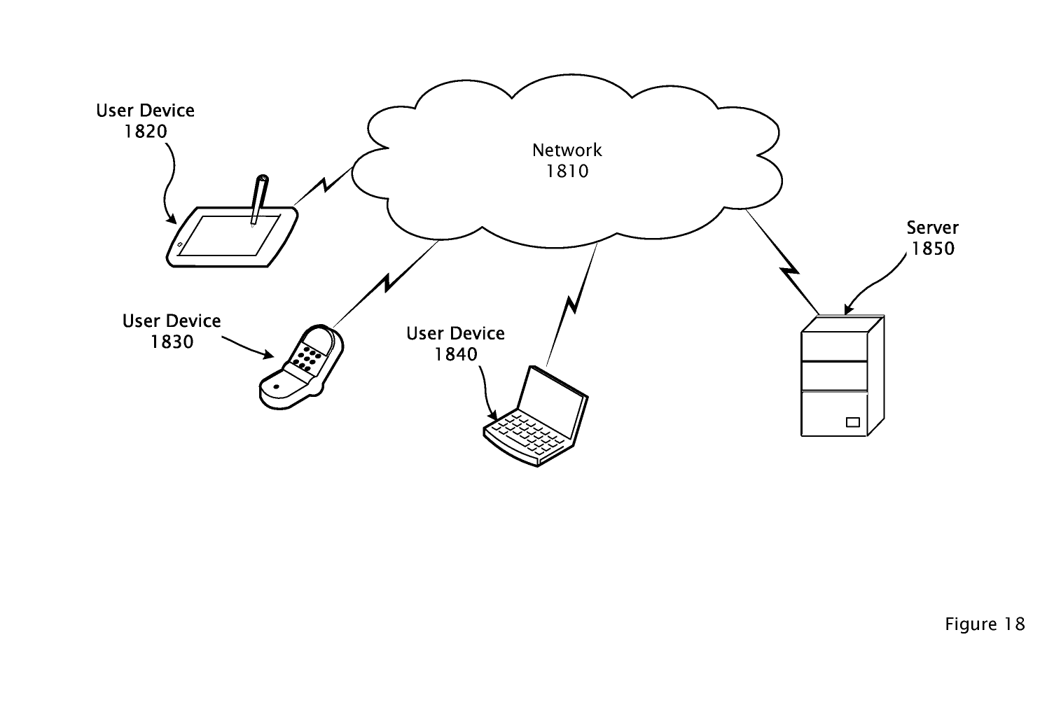

FIG. 18 illustrates a system capable of supporting a Keyboard, according to one embodiment. One or more User Device 1820, 1830, 1840 may be coupled to each other, a server, or to other devices via Network 1810. User Device 1820, 1830, 1840 may include a smartphone, tablet, laptop computer, smartwatch, or intelligent eyewear, for example.

Network 1810 may include Wi-Fi, cellular data access methods, such as 3G or 4GLTE, Bluetooth, NFC, the internet, local area networks, wide area networks, or any combination of these or other means of providing data transfer capabilities. In one embodiment, Network 1810 may comprise Ethernet connectivity. In another embodiment, Network 1810 may comprise fiber optic connections.

Server 1850 may include one or more computers, and may serve several roles. Server 1850 may be conventionally constructed, or may be of a special purpose design for processing data. One skilled in the art will recognize that Server 1850 may be of many different designs and may have different capabilities.

Server 1850 may host applications, data, or other information supporting Keyboard.

User Device 1820, 1830, 1840 may be used to access information or programs on Server 1850. Such information or programs may include, for example, a Predictive Dictionary Engine, which may return suggestions based upon keys pressed on Keyboard.

User Device 1820, 1830, 1840 may also be coupled directly via Ethernet, Wi-Fi, Bluetooth, NFC, or other technologies. This may allow Keyboard on a User Device 1820, 1830, or 1840 to control another User Device 1820, 1830, or 1840, for example.

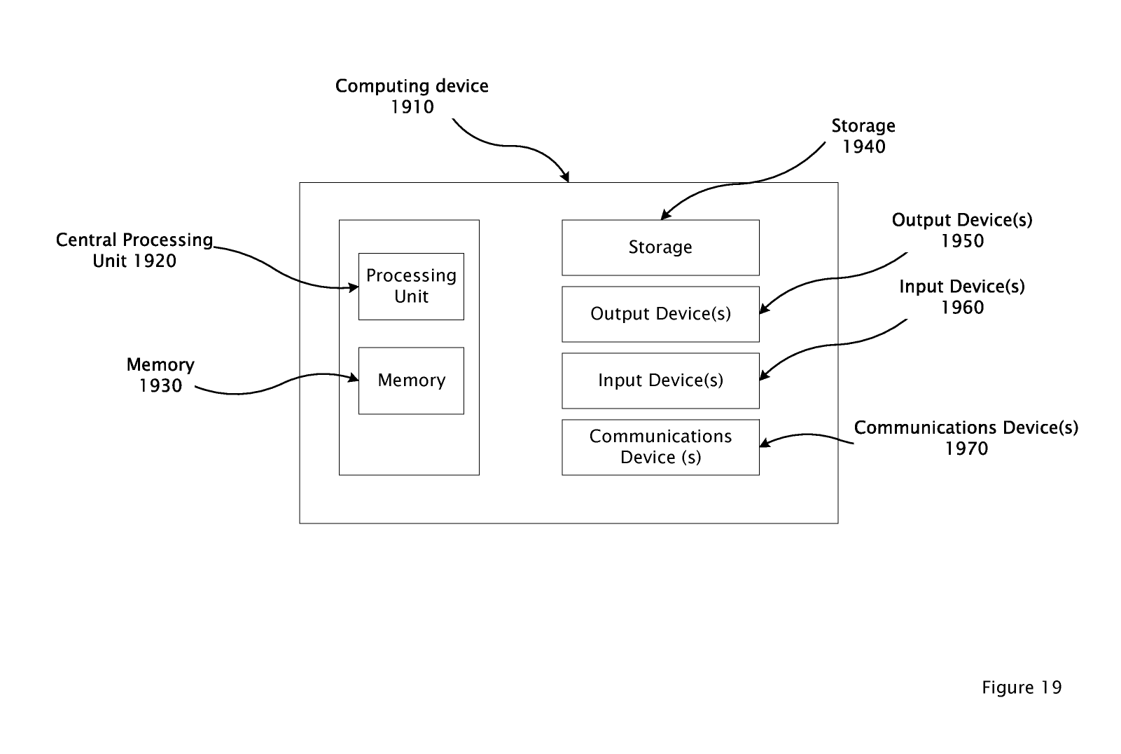

FIG. 19 illustrates a component diagram of a Computing Device 1910 according to one embodiment. Computing Device 1910 can be utilized to implement one or more computing devices, computer processes, or software modules described herein, including, for example, but not limited to a mobile device or a server. In one example, Computing Device 1910 may be used to process calculations, execute instructions, and receive and transmit digital signals. In another example, Computing Device 1910 may be utilized to process calculations, execute instructions, receive and transmit digital signals, receive and transmit search queries and hypertext, and compile computer code suitable for a mobile device. Computing Device 1910 may be any general or special purpose computer now known or to become known capable of performing the steps and/or performing the functions described herein, either in software, hardware, firmware, or a combination thereof.

In its most basic configuration, Computing Device 1910 typically includes at least one Central Processing Unit (CPU) 1920 and Memory 1930. Depending on the exact configuration and type of Computing Device 1910, Memory 1930 may be volatile (such as RAM), non-volatile (such as ROM, flash memory, etc.) or some combination of the two. Computing Device 1910 may also have additional features/functionality. For example, Computing Device 1910 may include multiple CPUs. The described methods may be executed in any manner by any processing unit in Computing Device 1910. For example, the described process may be executed by both multiple CPUs in parallel.

Computing Device 1910 may also include additional Storage 1940 (removable and/or non-removable) including, but not limited to, magnetic or optical disks or tape. Computer readable storage media include volatile and nonvolatile, removable and non-removable media implemented in any method or technology for storage of information such as computer-readable instructions, data structures, program modules or other data. Memory 1930 and Storage 1940 are all examples of computer-readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by Computing Device 1910. Any such computer-readable storage media may be part of Computing Device 1910. Computer readable storage media do not include transient signals. Computing Device 1910 may also contain Communications Device(s) 1 970 that allows the device to communicate with other devices. Communications Device(s) 1970 is an example of communication media. Communication media typically embody computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. The term computer-readable media as used herein includes both computer-readable storage media and communication media. The described methods may be encoded in any computer-readable media in any form, such as data, computer-executable instructions, and the like.

Computing Device 1910 may also have Input Device(s) 1960 such as keyboard, mouse, pen, voice input device, touch input device, etc. Output Device(s) 1950 such as a display, speakers, printer, etc. may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

Additionally, the illustrated operations in the description show certain events occurring in a certain order. In alternative embodiments, certain operations may be performed in a different order, modified or removed. Moreover, steps may be added to the above-described logic and still conform to the described embodiments. Further, operations described herein may occur sequentially, or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples, and data provide a complete description of the manufacture and use of the invention. Since many embodiments of the invention can be made without departing from the spirit and scope of the invention, the invention resides in the claims hereinafter appended.

1. A method, comprising:
receiving notification of a pressed key;
displaying one or more words based on the pressed key;
receiving notification of a swipe on the pressed key; and
selecting one of the displayed words based on a direction of the swipe.
